(19) United States
(12) Patent Application Publication
(10) Pub. No.: US 2007/0267400 A1
(43) Pub. Date: Nov. 22, 2007

(54) Automatic mirror defrosting device

(76) Inventors: Mei-Kuei Chen, Tucheng City (TW); Tsoung-Shu Huang, Sansia Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/798,196

(22) Filed: May 11, 2007

(30) Foreign Application Priority Data
May 19, 2006 (TW) 095208636

(51) Int. Cl. H05B 3/00

(52) U.S. Cl. 219/219

(57) ABSTRACT

An automatic mirror defrosting device includes a photo-electrical sensor arranged at a backside of a mirror to detect a frosting condition of a front surface of the mirror and to issue a detection signal corresponding to the frosting condition, a defrosting control circuit connected to the photo-electrical sensor for receiving the detection signal from the photo-electrical sensor to determine the frosting condition and selectively supply a defrosting heating signal, and a heating/defrosting device coupled to the backside of the mirror and connected to the defrosting control circuit to receive the defrosting heating signal from the defrosting control circuit for selectively carrying out heating operation on the mirror for defrosting. The heating operation is automatically terminated when an optic feedback from the front surface of the mirror obtained by the photo-electrical sensor indicates the front surface has been defrosted.

### BACKGROUND OF THE INVENTION

1. Field of the Invention

The present invention relates to an automatic mirror defrosting device, and in particular to an automatic defrosting device for mirrors that automatically detect the frosting condition and carry out defrosting operation in response to the detection of frosting of the mirror.

2. The Related Arts

Mirrors are widely used for personal make-up purposes. However, frosting often occurs on the mirror surface when the mirror is subject to environmental temperature/humidity change. A user of the mirror has to remove the frosting from the mirror surface, usually by manually wiping the mirror surface, for subsequent use of the mirror. This certainly causes troubles and problems in using the mirror.

A mirror heating device is also available for defrosting purposes. Such as conventional mirror heating/defrosting device is of a simple structure, including a switch to manually set for selectively supply power to the heating/defrosting device for heating the mirror surface. The operation is certainly troublesome and may sometimes lead to overheating of the mirror, resulting in cracking of the mirror or even dangers to the user, such as fire or electrical shock.

Prior art references, such as Taiwan Patent No. 134733 and Taiwan Utility Model No. 227336, disclose mounting contact type or resistor based temperature and humidity detection resistor on a mirror surface for detecting frosting condition of the mirror surface by means of change of resistance thereof caused by being heated or subject to humid environment. However, the known devices require the resistor or sensor be in tight engagement with the mirror surface and exposed outside the mirror surface. Thus, the installation of the conventional devices is difficult, and cause negative influence on the outside appearance of the mirror. In addition, errors caused by sensor itself often result in remarkable error in the defrosting process.

Therefore, it is desired to have a mirror defrosting device that overcomes the above discussed problems.

### SUMMARY OF THE INVENTION

Thus, an objective of the present invention is to provide an automatic mirror defrosting device that comprises a photo-electrical sensor that carries out precise detection of frosting condition of a mirror surface in a non-contact manner.

Another objective of the present invention is to provide an automatic mirror defrosting device that comprises a defrosting control circuit and a heating/defrosting device wherein the defrosting control circuit is connected to a photo-electrical sensor and the heating/defrosting device to receive a signal indicating the frosting condition of a mirror surface from the photo-electrical sensor and, in turn, to control the heating/defrosting device to selectively carry out a defrosting process on the mirror surface and wherein the photo-electrical sensor provides an optic feedback of the defrosting operation of the mirror surface so as to realize a closed-loop mirror defrosting operation.

To realize the objectives, the present invention provides an automatic mirror defrosting device comprising a photo-electrical sensor arranged at a backside of a mirror to detect a frosting condition of a front surface of the mirror and to issue a detection signal corresponding to the frosting condition, a defrosting control circuit connected to the photo-electrical sensor for receiving the detection signal from the photo-electrical sensor to determine the frosting condition and selectively supply a defrosting heating signal, and a heating/defrosting device coupled to the backside of the mirror and connected to the defrosting control circuit to receive the defrosting heating signal from the defrosting control circuit for selectively carrying out heating operation on the mirror for defrosting. The heating operation is automatically terminated when an optic feedback from the front surface of the mirror obtained by the photo-electrical sensor indicates the front surface has been defrosted.

### BRIEF DESCRIPTION OF THE DRAWINGS

The present invention will be apparent to those skilled in the art by reading the following description of a preferred embodiment thereof, with reference to the attached drawings, wherein:

FIG. 1 is a schematic view illustrating an automatic mirror defrosting device in accordance with the present invention mounted to a mirror;

FIG. 2 is a schematic side elevational view of FIG. 1;

FIG. 3 is a plan view of a photo-electrical sensor that comprises in part the automatic mirror defrosting device of the present invention;

FIG. 4 is a cross-sectional view of a portion of a mirror to which the automatic mirror defrosting device is mounted, to illustrate the photo-electrical sensor coupled to a backside of the mirror for detecting the frosting condition of a front surface of the mirror; and

FIG. 5 is a block circuit diagram of a defrosting control circuit of the automatic mirror defrosting device in accordance with the present invention.

### DETAILED DESCRIPTION OF THE PREFERRED EMBODIMENT

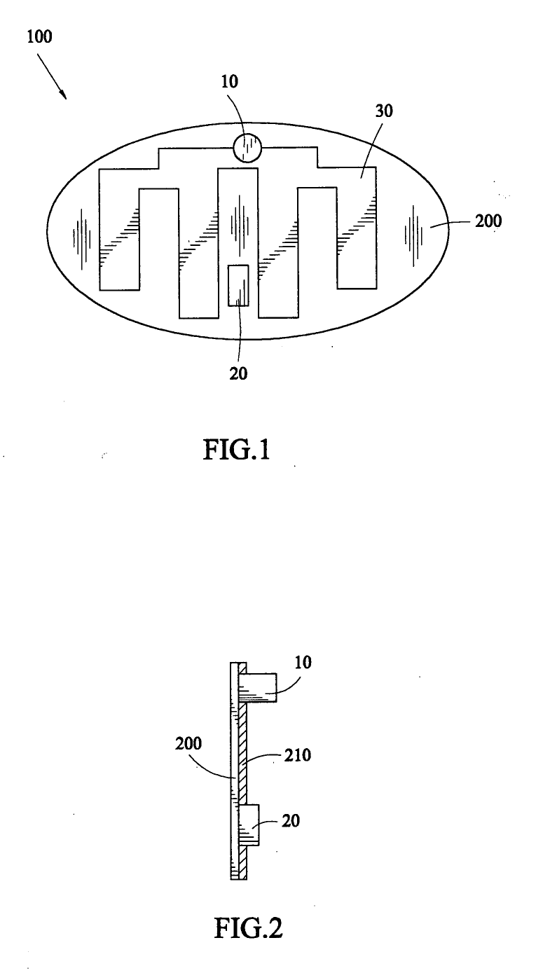

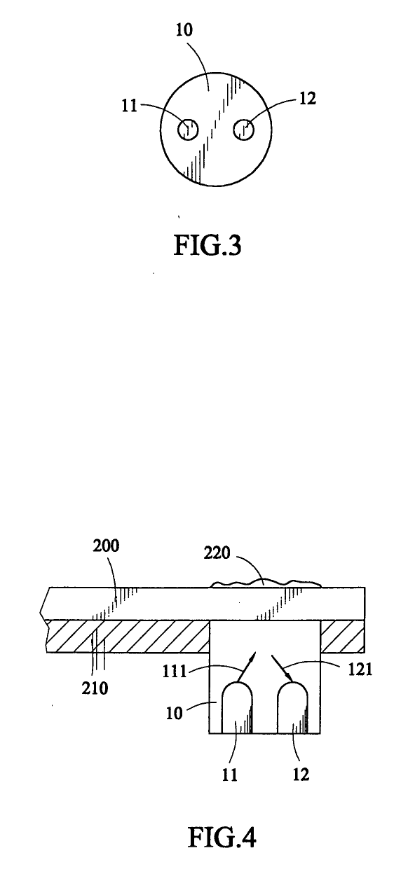

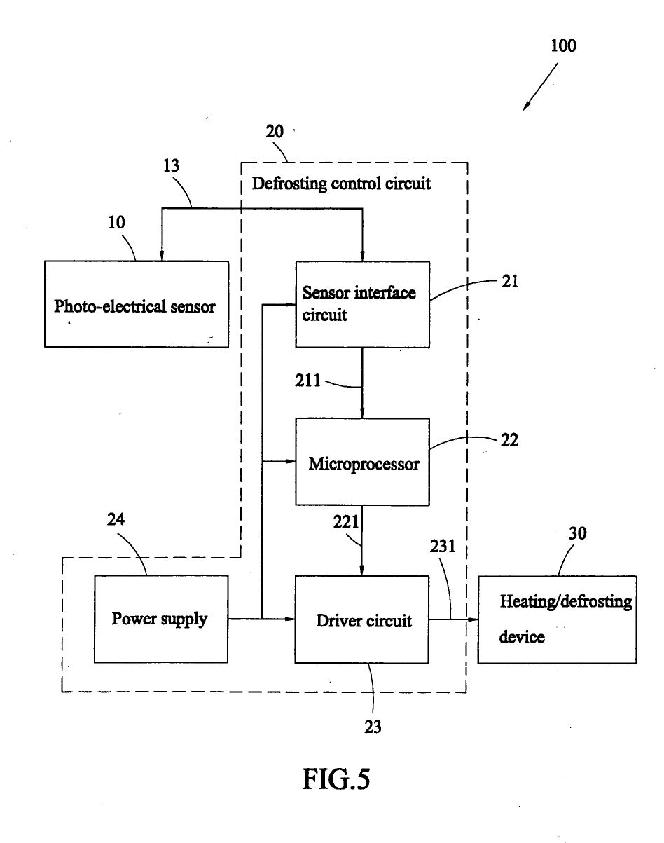

With reference to the drawings and in particular to FIGS. 1-4, an automatic mirror defrosting device constructed in accordance with the present invention, generally designated with reference numeral 100, is shown. The automatic mirror defrosting device 100 comprises a photo-electric sensor 10, a defrosting control circuit 20, and a heating/defrosting device 30. The photo-electrical sensor 10 is arranged on a backside of a mirror 200 and a portion of a reflective layer 210 that is coated on the backside of the mirror 200 is removed at an area corresponding to the location where photo-electrical sensor 10 is positioned, as shown in FIGS. 2 and 3, whereby the photo-electrical sensor 10 may detect the condition of a front surface of the mirror 200.

The photo-electrical sensor 10 comprises at least a transmitter 11 and a receiver 12. The transmitter 11 transmits an emission signal 111 toward the front surface of the mirror 200 and the receiver 12 receives a reflected signal 121 that is generated as a reflection of the emission signal 111 caused by the front surface of the mirror 200, whereby the photo-electrical sensor 10 outputs a detection signal 13 that indicates the frosting condition of the front surface of the mirror 200, as shown in FIG. 5.

Frosting or condensates 220 formed on the front surface of the mirror 200 reflects the emission signal 111 that is transmitted by the transmitter 10 toward the front surface of the mirror 200 and generates the reflected signal 121 that is received by the receiver 12 to output the detection signal 13. Thus, the detection signal 13 indicates the frosting condition of the front surface of the mirror 200. If there is no frosting formed on the front surface of the mirror 200, the detection signal 13 indicates there is no frosting on the front surface of the mirror 200.

Also referring to FIG. 5, the defrosting control circuit 20 is arranged on a circumference of the mirror 20, or preferably, at the backside of the mirror 200. The defrosting control circuit 20 comprises a sensor interface circuit 21, a microprocessor 22, a driver circuit 23, and a power supply 24. The sensor interface circuit 21 is connected to the photo-electrical sensor 10 for driving the photo-electrical sensor 10 and converting the detection signal 13 supplied by the photo-electrical sensor 10 into a digital signal 211. The microprocessor 22 is connected to the sensor interface circuit 21 to receive the digital signal 211, based on which the microprocessor 22 determines if there is fronting 220 formed on the front surface of the mirror 200 and generates a defrosting driving signal 221. The driver circuit 23 is connected to the microprocessor 22 to receive the defrosting driving signal 211 from the microprocessor 22 and, in response thereto, to supply a defrosting heating signal 231. The power supply 24 can be of any suitable type, such as a DC battery set or an AC/DC power converter, to supply operation power to the sensor interface circuit 21, the microprocessor 22, and the driver circuit 23.

The heating/defrosting device 30 is coupled to the backside of the mirror 200, and can be of any suitable type, such as printed heating wire pattern that is directly printed on the backside of the mirror 200. The heating/defrosting device 30 is connected to the driver circuit 23 of he defrosting control circuit 20 to receive the defrosting heating signal 231 from the driver circuit 23 and, in response thereto, to selectively heat the mirror 200 for performing defrosting.

The automatic mirror defrosting device 100 carries out precise detection of frosting 220 on the front surface of the mirror 200 in a non-contact manner by the photo-electrical sensor 10 and to automatically determine the frosting condition 220 by means of the microprocessor 22 to selectively drive the heating/defrosting device 3 for heating and thus defrosting the mirror 200. In the process of defrosting, a constant optical feedback is obtained through the photo-electrical sensor 10 whereby the process of defrosting by heating is terminated at the time when the optical feedback indicates the mirror surface has been completely defrosted or has been defrosted to a predetermined extent.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An automatic mirror defrosting device, comprising:
at least a photo-electrical sensor adapted to arrange at a backside of a mirror to detect a frosting condition of a front surface of the mirror and to issue a detection signal corresponding to the frosting condition;
a defrosting control circuit connected to the photo-electrical sensor for receiving the detection signal from the photo-electrical sensor to determine the frosting condition and selectively supply a defrosting heating signal; and
a heating/defrosting device coupled to the backside of the mirror and connected to the defrosting control circuit to receive the defrosting heating signal from the defrosting control circuit for selectively carrying out heating operation on the mirror for defrosting.

2. The automatic mirror defrosting device as claimed in claim 1, wherein the photo-electrical sensor comprises at least a transmitter and a receiver, the transmitter transmitting an emission signal toward the front surface of the mirror, the emission signal being reflected by the front surface of the mirror as a reflected signal that is received by the receiver to indicate the frosting condition of the front surface of the mirror.

3. The automatic mirror defrosting device as claimed in claim 1, wherein the defrosting control circuit comprises:
a sensor interface circuit connected to the photo-electrical sensor for driving the photo-electrical sensor and for converting the detection signal from the photo-electrical sensor into a digital signal;
a microprocessor connected to the sensor interface circuit for receiving the digital signal to determine, based on the digital signal, the frosting condition of the front surface of the mirror and supply a defrosting driving signal in response thereto;
a driver circuit connected to the microprocessor to receive the defrosting driving signal from the microprocessor and to supply the defrosting heating signal in response thereto; and
a power supply for powering the sensor interface circuit, the microprocessor, and the driver circuit.

4. The automatic mirror defrosting device as claimed in claim 3, wherein the power supply comprises a DC battery set.

5. The automatic mirror defrosting device as claimed in claim 3, wherein the power supply comprises an AC/DC power converter.

6. The automatic mirror defrosting device as claimed in claim 1, wherein the heating/defrosting device comprises printed heating wires.
